(19) United States
(12) Patent Application Publication
(10) Pub. No.: US 2025/0245475 A1
(43) Pub. Date: Jul. 31, 2025

(54) Digital Personas and Subject Matter Expert Knowledge Sharing Using Generative AI

(71) Applicant: KPMG International Services Ltd, Montvale, NJ (US)

(72) Inventors: Anna MacFarlane, Auckland (NZ); Martin Ooi, Auckland (NZ); Mihali Grispos, Short Hills, NJ (US); Joel Williams, Seattle, WA (US); Fatima Purizaga, Lima (PE)

(73) Assignee: KPMG International Services Ltd., Montvale, NJ (US)

(21) Appl. No.: 19/040,189

(22) Filed: Jan. 29, 2025

Related U.S. Application Data
(60) Provisional application No. 63/626,719, filed on Jan. 30, 2024.

(51) Int. Cl. G06N 3/006; G06F 16/953

(52) U.S. Cl. CPC G06N 3/006; G06F 16/953

(57) ABSTRACT

Methods and systems are provided for using personas in conjunction with an artificial intelligence (AI) model to provide answers to user prompts. In an embodiment, a method includes selecting a persona for use in responding to a user prompt, and using the AI model to determine a data source best able to provide an answer to the user prompt, search one or more data sources based on the user prompt and the selected persona, and generate an answer to the user prompt based on search results obtained from the one or more data sources.

### CROSS-REFERENCE TO RELATED APPLICATIONS

This application claims the benefit of U.S. Provisional Application No. 63/626,719 filed Jan. 30, 2024, which is incorporated herein in its entirety.

### TECHNICAL FIELD

The disclosed implementations relate generally to digitally created personas for interaction with users and subject matter expert knowledge (SME) sharing to users, both using large language models as generative artificial intelligence (AI) engines.

### BACKGROUND OF THE INVENTION

An avatar or digital twin model can used as a representation of a person using a service. They may be in the form of a two-dimensional model or a three-dimensional model to provide a graphical representation to the user of a generative AI model responding to prompts. However, known avatar or digital twin solutions provide only mostly static representations of intelligence rather than responsiveness, as one expects when interacting with generative AI models.

### SUMMARY OF THE INVENTION

Embodiments of the present invention provide exemplary systems and methods for providing a virtual persona for interacting with generative AI model users or for providing SME answers. In exemplary embodiments, a user input to a particular virtual persona is received by a virtual persona system. The user input may be a question directed to a virtual persona or to an SME persona.

In one embodiment, a method includes selecting a persona for use in responding to a user prompt and using the AI model to determine a data source best able to provide an answer to the user prompt, search one or more data sources based on the user prompt and the selected persona, and generate an answer to the user prompt based on search results obtained from the one or more data sources.

### BRIEF DESCRIPTION OF DRAWINGS

Embodiments of the invention are illustrated by way of example and not by way of limitation in the figures of the accompanying drawings.

FIG. 1 is a block diagram of a system for creating and using a question-and-answer persona or SME persona.

FIG. 2 is a more detailed diagram of the system shown in FIG. 1.

FIG. 3 is a flowchart illustrating a method of using the system of FIG. 2 to create general personas and SME personas.

FIG. 4 is a user interface illustration that provides an example of the interaction between user and persona via a chat tool.

FIG. 5 is an example user interface of a persona selection mechanism in which personas are presented on a carousel rather than as icons in a chat application.

FIG. 6 is an example user interface of the chat application that may be used with the selection mechanism illustrated in FIG. 5.

FIG. 7 is an example user interface of a persona generator that enables a user to specify desired demographics, roles, and capabilities.

### DETAILED DESCRIPTION OF THE INVENTION

In the following description, details of embodiments of the invention are provided for

the purposes of explanation and to provide a more thorough understanding. One or more embodiments may be practiced without these specific details, or with only some of the specific details and not others. Features described in one embodiment may be combined with features described in a different embodiment.

A traditional persona is an archetype that represents a real person. Personas are used alongside process flows and use cases to drive decision making for the implementation of change. Personas are traditionally built through segmentation, real life focus groups, and profiling. However, traditional methods are (a) expensive, logistically onerous, and time-consuming; (b) have limited accessibility during prototyping and customer/user experience testing phases; (c) have outputs impacted by unconscious biases of users when deciding on the reaction of a traditional persona; and (d) are set at a fixed point in time.

Similarly, SMEs are in high demand and difficult to access. Moreover, firms can get lost in detail such that usable information is not provided by SMEs or key types of information can be left out. Creating SME personas is generally a manual, time-consuming process, especially in trying to discern what needs to be reported when and in plain language rather than with too much intricate detail.

Embodiments of the invention provide a means for building general and SME personas by combining the concepts of traditional personas and that of a digital twin. Powered by AI, particularly by a generative AI model, a persona can grow and develop based on the changing profile of the person or people it is designed to represent. The invention's personas are interactive, answering questions in real time. Moreover, the invention can purposefully include bias to better reflect those present in a real-world person rather than the impact of biases of the user interacting with the persona. Further, cost and convenience are significantly enhanced for users as personas are accessible 24/7 and can scale up much easier than using real-world people.

One or more embodiments provide a generalized persona that utilizes a chat-enabled generative AI model with a digital twin overlay to provide an enhanced user experience. Other embodiments provide an SME persona that uses search functionalities by an AI model against preloaded documents, with new data objects created upon the model's first encounter for easier searching thereafter. The search output is then used as a prompt into a generative AI model.

Embodiments of the invention thus offer several benefits. In particular, embodiments of the invention include general personas that provide accelerated testing phases of new products or services, especially when consumer sentiment or input is useful. The invention also provides 24/7 accessibility to customer responses and enables removal of user bias. Embodiments also includes SME personas that reduce the need for human expert time, enabling those human experts to focus on their core jobs. Embodiments also centralize access to expert information and democratizes employee access to resources, resulting in more employee engagement with experts in furtherance of connective or educational goals of a company. Smaller companies also can have access to experts they would otherwise be without. Moreover, SME personas enable users to ask detailed domain-specific questions and receive usable plain language responses, grounded in facts and cross referenced to relevant documentation. Both types of personas enable broader use of internal company documentation without the risk of leakage that can occur when actual humans are involved.

The embodiments described herein represent an improvement to existing technologies by providing specific technology that uses AI, such as suitable large language models (LLMs), to create new opinion personas and to enable SME personas to search for technical answers. Thus, implementations improve the speed and accuracy of testing phases where public sentiment is important and enable broader access to expert-level knowledge to a specific domain, which would not be available otherwise. The embodiments described herein therefore do not merely recite the performance of some business practice known from the pre-computer world along with the requirement to perform it on a computer. Rather, these embodiments incorporate one or more AI models to enable use of new or custom data, including aggregated or synthetic data. Thus, the embodiments described herein are necessarily rooted in new computer technology to overcome a problem specific to generating personas for use in gathering public feedback and in querying for answers at an expert level. In addition, the present disclosure includes specific features other than what is well-understood, routine, conventional activity in the field, and/or add unconventional steps that confine the claim to a particular useful application, e.g., enabling further learning as feedback to enable more accurate analyses or suitable response, as described herein.

The systems and methods described herein use AI, such as suitable large language models (LLMs), to provide functionality and the ability to create new opinion personas and to enable SME personas to search for technical answers. An LLM can be trained on anonymized and/or synthetic data, for example. The training data may be received in several ways including, but not limited to, from databases, data vendors, file upload, etc. The embodiments described herein use a pre-trained LLM such as those available from OpenAI or Alphabet. The LLM 108 consists of multiple layers of neural networks and may be trained to generate a number of analyses as described below. In the pre-training phase, a large dataset is acquired from the internet, including text from a high number of sources to ensure the LLM learns a broad spectrum of language patterns. The data is cleaned and preprocessed to remove noise, formatting issues, and irrelevant information. This process could be done via scripting, a machine learning model, or even another LLM that has already been trained. The data is then tokenized into smaller units, such as words or subword pieces. In some embodiments, the LLM has a transformer architecture that can be used due to its effectiveness in handling sequential data. Pre-training of the LLM occurs by training the model to predict the next word in a sequence of text, using the cleaned dataset, to enable it to understand and generate human-like language.

The next phase of training the LLM is tuning. The tuning phase may be supervised or unsupervised. However, in either case, during this phase the LLM is provided with an input prompt and the trainer's response as the target. The LLM can thus learn to generate responses by minimizing the difference between its predictions and the provided responses.

The third phase is training the LLM is reinforcement learning. Generally, this is based on human feedback. However, a trained LLM could act as the feedback mechanism for the LLM undergoing training. During this phase, the trainer (human or LLM) will input a prompt to the LLM 108 multiple times, generally receiving slightly different outputs. The trainer then ranks the outputs.

During use, the LLM can respond to user prompts to according to a selected persona and/or with suitable subject matter expertise. Moreover, the user prompts can include demographic data, actual responses to questionnaires (such as personality tests), or subject-specific data related to climate in order to provide context to the LLM as it generates responses. In addition, these types of data can be used to specify persona details to the LLM that should be used when generating responses. The responses of the selected persona or SME can also be used to further train the LLM. For example, the responses can be used as additional training data as described above such that the weights and vectors of the LLM can be changed based on the frequency or repetition of specific words or phrases.

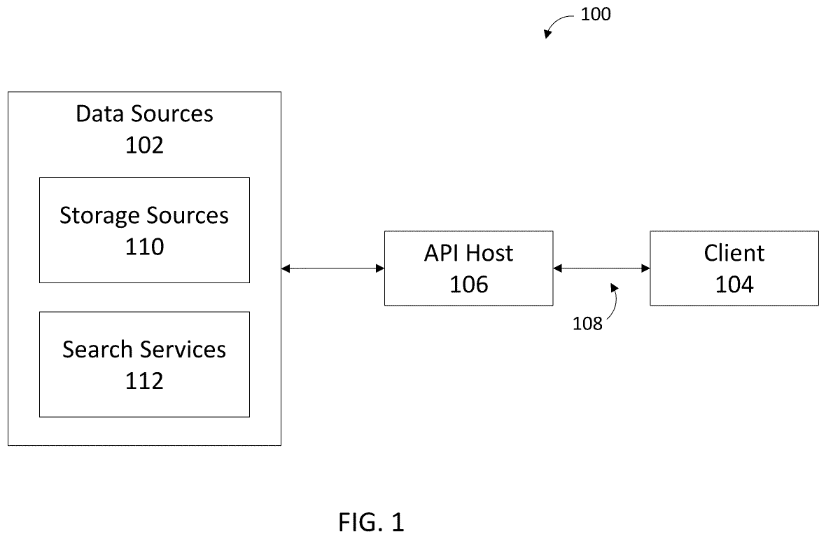

FIG. 1 shows a block diagram of a system 100 for creating and using a question-and-answer persona or SME persona. The system 100 includes one or more data sources device 102, one or more client devices 104, and an application programming interface (API) host 106, interconnected via a network 108.

The data sources device 102 may host one or more applications, such as storage services modules or devices 110 (hereinafter “storage sources”) and one or more search services modules 112 (hereinafter “search services”). The storage sources 110 include one or more types of memory that can include volatile and nonvolatile, removable and non-removable media implemented in any method or technology for storage of information such as computer-readable instructions, data structures, program modules, or other data. The memory may include one or more physical persistent memory devices and/or one or more non-persistent memory devices. The search services 112 may be special purpose circuits or processors, for example, that enable search of the storage sources 110 by the client device 104 via the API host 106.

More specifically, the storage sources 110 may include storage devices configured to maintain, store, retrieve, and update information for the data sources device 102. Further, the storage sources 110 may provide the data sources device 102 with information periodically or upon request. In this regard, the storage sources 110 may be a distributed database capable of storing, maintaining, and updating large volumes of data across clusters of nodes. The storage sources 110 may provide a variety of databases including, but not limited to, relational databases, hierarchical databases, distributed databases, in-memory databases, flat file databases, XML databases, NoSQL databases, graph databases, and/or a combination of any of these.

The client device 104 may access the search services 112 via the API 106 using one or more client applications, such as a web browser or application. A client device 104 may be a mobile device, such as a laptop, smart phone, or tablet, or computing devices, such as a desktop computer or a server.

The API host 106 may provide instructions that allow the data sources device 102 and the client device 104 to together perform various actions. In some embodiments, the API host 106 can be connected to an LLM (not shown in FIG. 1) by network 108. Alternatively, the API host 106 can house the LLM. The LLM may be prompted to query the storage sources 110 via the search services 112 by building a prompt based on user input from the client device 104. Prompts to a pre-trained LLM may include demographic information of a group of testers and personality test answers from the group of testers. The demographic and personality test information can help form biases and opinions that the system 100 uses to respond to prompts or questions sent from the client device 104 by a user. Prompts to the LLM may also include providing subject matter relevant to a specific matter. For example, documents can be provided to the LLM related to climate change globally and/or how climate change may affect a given region or country. The LLM may also be linked to the Internet to enable searches based on specific prompts. Search results can then be indexed by the LLM and considered as any other data object.

Regarding the network 108, it should be noted that the network connections shown are illustrative and any means of establishing a communications link between the computers may be used. The existence of any of various network protocols such as TCP/IP, Ethernet, File Transfer Protocol (FTP) or Secure FTP (SFTP), HTTP and the like, and of various wireless communication technologies such as GSM, CDMA, Wi-Fi, LTE, and 5G is presumed, and the various computing devices described herein may be configured to communicate using any of these network protocols or technologies.

Moreover, the network 108 may include any type of network. For example, the network 110 may include a local area network (LAN), a wide area network (WAN), a wireless telecommunications network, and/or any other communication network or combination. It will be appreciated that the network connections shown are illustrative and any means of establishing a communications link between the computers may be used. The existence of any of various network protocols such as TCP/IP, Ethernet, FTP, SFTP, HTTP and the like, and of various wireless communication technologies such as GSM, CDMA, Wi-Fi, LTE, and 5G, is presumed, and the various computing devices described herein may be configured to communicate using any of these network protocols or technologies.

The data transferred to and from various computing devices in system 100 may include secure and sensitive data, such as confidential documents, client personally identifiable information, and account data. Therefore, it may be desirable to protect transmissions of such data using secure network protocols and encryption, and/or to protect the integrity of the data when stored on the various computing devices. For example, a file-based integration scheme or a service-based integration scheme may be utilized for transmitting data between the various computing devices. Data may be transmitted using various network communication protocols. Secure data transmission protocols and/or encryption may be used in file transfers to protect the integrity of the data, for example, FTP, SFTP, and/or Pretty Good Privacy (PGP) encryption. In many embodiments, one or more web services may be implemented within the various computing devices. Web services may be accessed by authorized external devices and users to support input, extraction, and manipulation of data between the various computing devices in the system 100. Web services built to support a personalized display system may be cross-domain and/or cross-platform and may be built for enterprise use. Data may be transmitted using the Secure Sockets Layer (SSL) or Transport Layer Security (TLS) protocol to provide secure connections between the computing devices. Web services may be implemented using the WS-Security standard, providing for secure SOAP messages using XML encryption. Specialized hardware may be used to provide secure web services. For example, secure network appliances may include built-in features such as hardware-accelerated SSL and HTTPS, WS-Security, and/or firewalls. Such specialized hardware may be installed and configured in the system 100 in front of one or more computing devices such that any external devices may communicate directly with the specialized hardware.

Any of these devices described above may be implemented, in whole or in part, using one or more computing devices as now described. An example computing device may include one or more processors for controlling overall operation of the computing device and its associated components, including RAM, ROM, input/output device, communication interface, and/or memory, all connected via a data bus. In some embodiments, the computing device may represent, be incorporated in, and/or include various devices such as a desktop computer, a computer server, a mobile device, such as a laptop computer, a tablet computer, a smart phone, any other types of mobile computing devices, and the like, and/or any other type of data processing device.

An I/O device may include a microphone, keypad, touch screen, and/or stylus through which a user of the computing device may provide input and may also include one or more of a speaker for providing audio output and a video display device for providing textual, audiovisual, and/or graphical output. Software may be stored within a memory to provide instructions to the processor allowing the computing device to perform various actions. For example, the memory may store software used by the computing device, such as an operating system, storage sources 110, and/or search services 112. The various hardware memory units in the memory may include volatile and nonvolatile, removable and non-removable media implemented in any method or technology for storage of information such as computer-readable instructions, data structures, program modules, or other data. The memory may include one or more physical persistent memory devices and/or one or more non-persistent memory devices. In some embodiments, RAM and/or ROM may be part of the memory along with electronically erasable programmable read only memory (EEPROM), flash memory or other memory technology, optical disk storage, magnetic cassettes, magnetic tape, magnetic disk storage or other magnetic storage devices, or any other medium that may be used to store the desired information and that may be accessed by the processor.

The communication interface may include one or more transceivers, digital signal processors, and/or additional circuitry and software for communicating via any network, wired or wireless, using any protocol as described above.

The processor may include a single central processing unit (CPU), which may be a single-core or multi-core processor or may include multiple CPUs. The processor and associated components may allow the computing device to execute a series of computer-readable instructions to perform some or all of the processes described herein. Various elements within the memory or other components in the computing device, may include one or more caches, for example, CPU caches used by the processor, page caches used by the OS, disk caches of a hard drive, and/or database caches used to cache content from the storage sources 110. For embodiments including a CPU cache, the CPU cache may be used by one or more processors to reduce memory latency and access time. A processor may retrieve data from or write data to the CPU cache rather than reading/writing to the memory, which may improve the speed of these operations. In some examples, a database cache may be created in which certain data from the storage sources 110 is cached in a separate smaller database in a memory separate from the database, such as in RAM or on a separate computing device. For instance, in a multi-tiered application, a database cache on an application server may reduce data retrieval and data manipulation time by not needing to communicate over a network with a back-end database server. These types of caches and others may be included in various embodiments and may provide potential advantages in certain implementations of devices, systems, and methods described herein, such as faster response times and less dependence on network conditions when transmitting and receiving data.

Although various components of the computing device are described separately, functionality of the various components may be combined and/or performed by a single component and/or multiple computing devices in communication without departing from the invention.

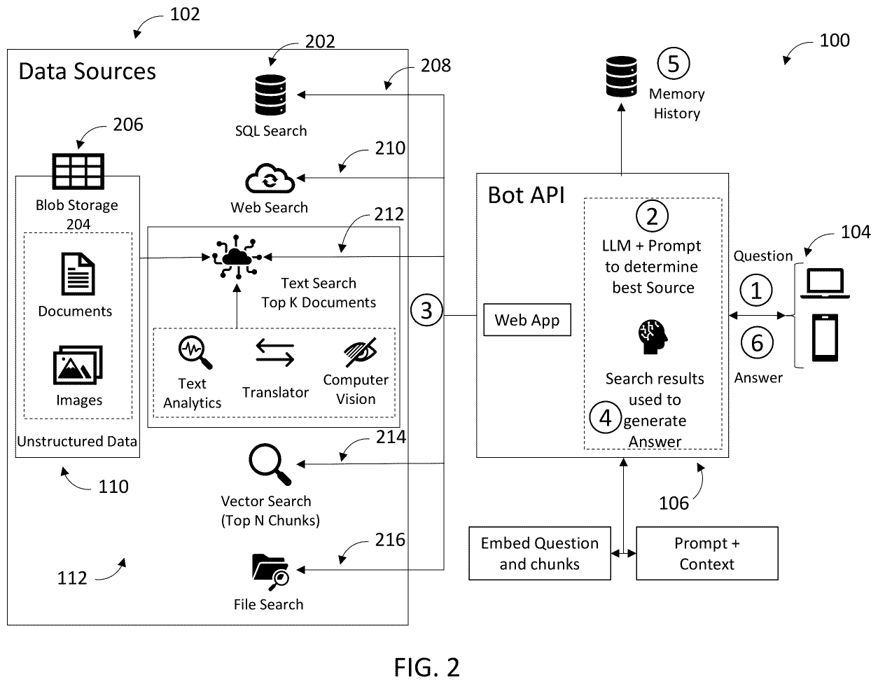

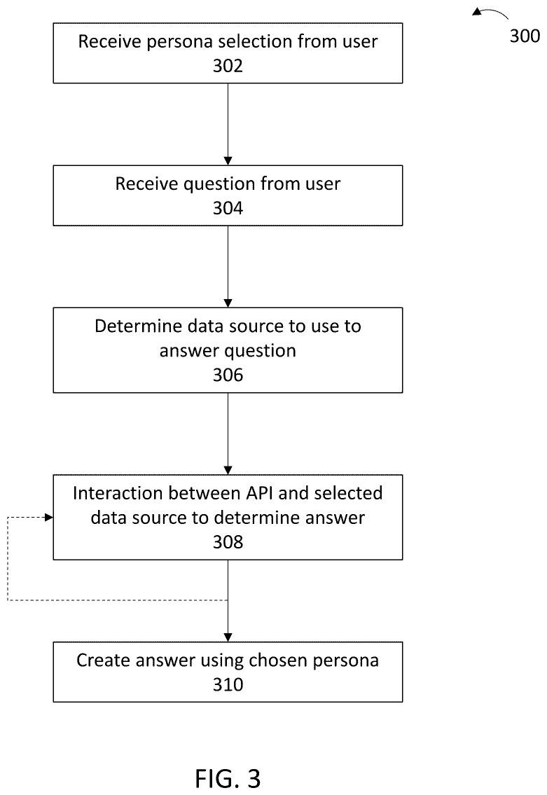

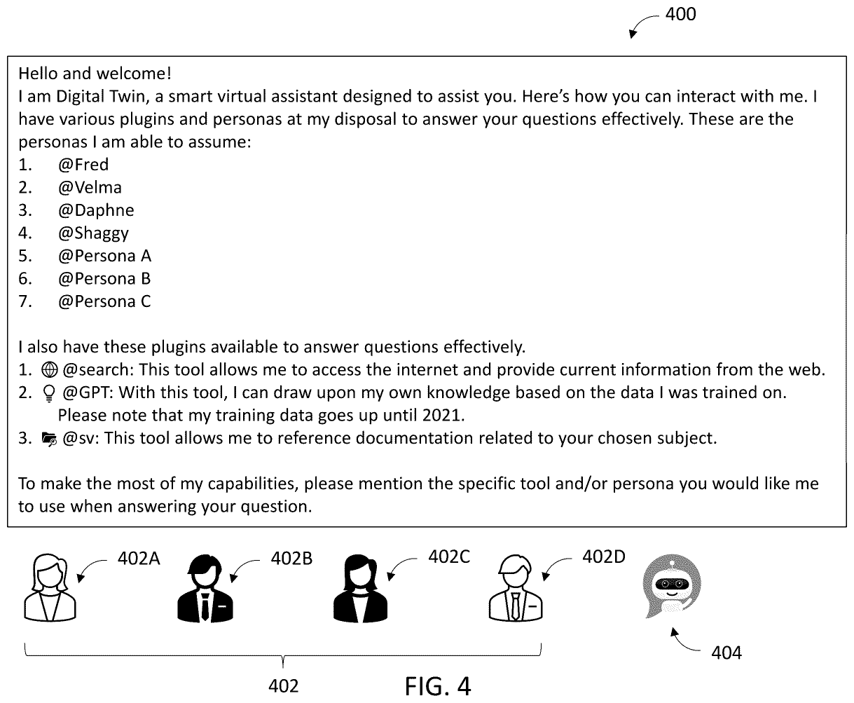

FIG. 2 is a more detailed diagram of the system 100 shown in FIG. 1. FIG. 3 is a flowchart illustrating a method of using the system 100 of FIG. 2 to create general personas and SME personas for use with an LLM. FIG. 4 is a user interface illustration that provides an example of the interaction between user and persona via a chat tool, such as Microsoft Teams. It should be noted that other chat tools may be used.

Initially, a user can create a new persona. To create a new general persona, a prompt to the LLM includes information, such as surveys and the like, related to desired demographics and/or personality aspects of the persona to be used in responding. To create a new SME persona, a prompt to the LLM includes specific factual data on the desired subject matter, such as technical papers, datasets, web search instructions, and the like.

After the relevant personas are created, users can interact with them. More specifically, users can interact with the LLM that the personas overlay—asking questions and receiving answers, whether opinion-based answers from a selected general persona or fact- and research-based answers from an SME persona. As shown in FIG. 3, a user selects 302 a persona to interact with via the client device 104. As shown in FIG. 4, the user can select from a set of general personas 402, with each general persona 402A-D having a different set of behavioral characteristics and biases based on the creation criteria input into the LLM. The user can also select an SME persona 404 with a specialized knowledge base according to the creation criteria input into the LLM. The user's selected persona is communicated to the API host 106 for interaction with the LLM and the data sources device 102. In some embodiments, the user can select a panel of SME personas to obtain a variety of subject matter-based answers. In some embodiments, the user can select multiple general personas to obtain a variety of general answers that can reflect multiple personalities and sets of bias. In some embodiments, if the user does not select a persona a default persona will be used by the API host 106 to interact with the LLM and the data sources device 102. For example, if the LLM detects that a question posed by a user is directed to a fact-based answer, the LLM will use an SME persona to provide an answer. On the other hand, if the LLM detects that a question posed by a user is directed to opinion or insights, the LLM will use a default general persona.

After selecting 302 a desired persona, the user enters 304 a question or prompt via the client device 104. This is also reflected by item 1 in FIG. 2. In some embodiments, steps 302 and 304 can be combined into a single entry as shown by the prompts in FIG. 4. For example, in FIG. 4 the user is prompted to enter a selected persona as part of the prompt as well as to designate a specific plugin, which can be a desired search service 112.

The API host 106 determines 306 which data sources to use to answer the question. For example, the API host 106 may parse the question text to select keywords. Alternatively, the LLM may itself select the proper data sources to use based on the question itself. As shown in FIG. 2 at item 2, the API host 106 may interact with the LLM and the input prompt to determine the best source by embedding the question and chunks in communications to the LLM as well as providing additional context. As shown at item 3 in FIG. 2, the data sources device 102 interacts with the API host 106 and LLM to determine the proper search service 112 and/or storage source 110. In some embodiments, the storage sources 110 can include an SQL database 202, a blob storage unit 204 that includes unstructured data objects, or a tabular file 206, such as a CSV or Microsoft Excel file. The storage sources 110 can include other suitable storage types, such as, but not limited to, XML files, JSON files, and the like. The search services 112 can include SQL search modules 208, web search services modules 210 (e.g., Microsoft Bing), text search modules 212, vector search modules 214, and/or file search modules 216. Other suitable search services or modules can also be used. Alternative, the LLM can directly provide answers to the user prompt according to the selected or default persona.

After determining 306 the proper storage source 110 and search service 112 to use, the API host 106 and LLM interact 308 with the data sources device 102 to find one or more answers to the input prompt from the user. As shown by the dotted line in FIG. 3, this can be an iterative process. In some embodiments, the API host 106 uses the LLM itself to provide answers to the user prompt based on additional information provided to the LLM as context as described above. In some embodiments, the API host 106 instructs the web search services 210 to conduct a web search. In some embodiments, the API host 106 instructs the text search modules 212 to conduct a search of the blob storage unit 204. For example, the text search modules 212 may use the LLM to vectorize the top K document chunks that are responsive to the user prompt, then create vector-based indices, then retrieve the top (e.g., the most responsive) N chunks based on a vector search of the vector-based indices by the vector search modules 214. In some embodiments, the API host 106 instructs the SQL search modules 208 to execute a search of the SQL database 202 using a search created by the LLM. In some embodiments, the API host 106 instructs the file search modules 216 to search one or more tabular files 206. In some embodiments, the search may involve more than one type of search service 112 and/or storage source 110.

Based on the information retrieved by the selected search service 112, the LLM constructs 310 an answer using generative AI capabilities, as shown at item 4 of FIG. 2. For example, the LLM may generate an answer based on the information retrieved by the selected search service 112 or stored in the storage sources 110. In embodiments with multiple LLMs, any given LLM may generate prompts for use by other LLMs. The LLM 108 uses its pre-trained knowledge and learned patterns in conjunction with identified persona details to analyze input and predict the most likely next word or sequence of words. This prediction is based on the context provided by the prompt and the patterns the LLM learned during its pre-training and any later supplemental training conducted on prompts and/or answers. The model's ability to generate coherent and contextually relevant responses is a result of its understanding of grammar, syntax, and semantic relationships between words. The generated output is probabilistic, whereby the LLM assigns a probability to each possible word or sequence of words. It then selects the most likely option based on these probabilities, but it can also explore alternative options by sampling from the probability distribution. This allows for some level of creativity and variation in the generated output. Prompts and responses are then saved into a memory as shown at item 5 of FIG. 2, which may be a database, blob storage, or some other suitable storage device. The LLM provides the response to the client device 104 via the API host 106, for display to the user as shown at item 6 of FIG. 2.

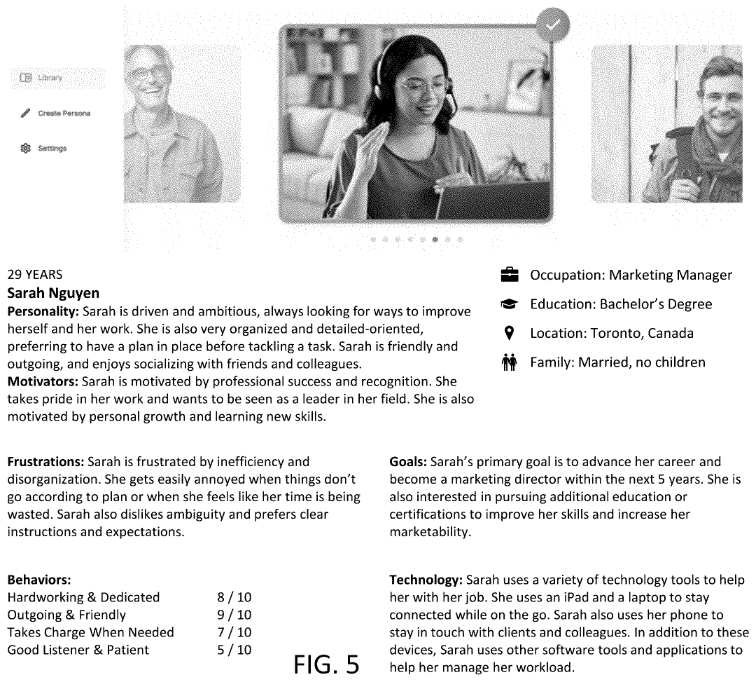

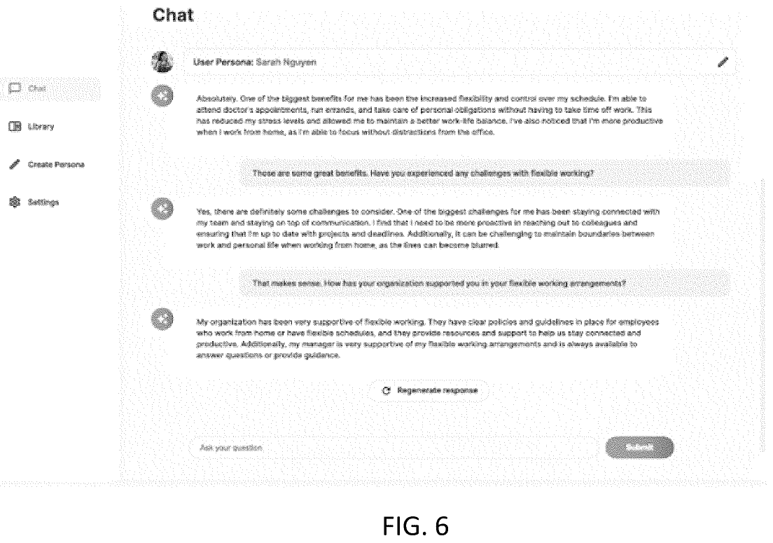

FIGS. 5 and 6 are example user interfaces of a persona selection mechanism in which personas are presented on a carousel rather than as icons in a chat application. As shown in FIG. 5, the user can view the demographic information of the displayed persona as well as other properties that may be relevant to selecting one persona over another. As shown in FIG. 5, a carousel interface is provided to the user with each persona having associated characteristics including name, age, occupation, educational attainment, location, and family characteristics such as marriage status and presence of children. Each persona page also includes descriptions of the persona's personality, motivators, frustrations, and goals. For example, the persona highlighted in FIG. 5 is named Sarah Nguyen who is 29 years old, works as a Marketing Manager after obtaining a bachelor's degree in marketing, lives in Toronto, Canada, and is married without children. The persona's personality is to be “driven and ambitious, always looking for ways to improve . . . organized and detail-oriented, preferring to have a plan in place before tackling a task . . . friendly and outgoing . . . ” Also as shown in FIG. 5, this persona is frustrated by inefficiency and disorganization . . . easily annoyed when things don't go according to plan . . . ” Each persona page also includes gauges of certain personality traits such as being hardworking and dedicated, outgoing and friendly, willing to take charge, and listening traits. Finally, each persona page includes a summary of the persona's technology skills. The demographic and personality characteristics of the persona inform the answers the LLM generates in response to user prompts. An SME persona may also include areas of specialized expertise. FIG. 6 is a sample chat user interface that may be used with the selected persona from FIG. 5.

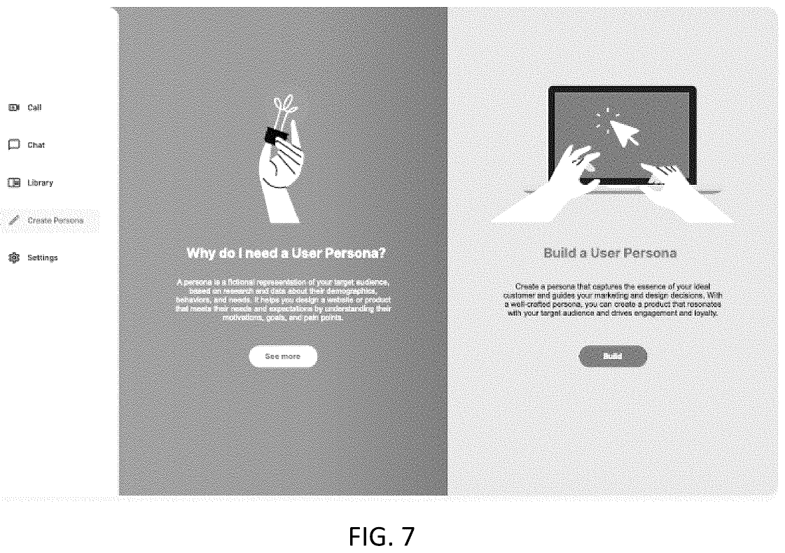

FIG. 7 is an example user interface of a persona generator that enables a user to specify desired demographics, roles, and capabilities. This can be valuable to polling or product review processes. Generative AI tools such as LLMs can be used to gather insight from publicly available or licensed data and/or from an organization's own insights to build a profile of a persona's motivations and expectations. The LLM or another suitable AI model can design the persona's empathy map and use the empathy map to answer what the persona would think, feel, and do as a result of a user prompt.

In some embodiments, a persona could be combined with virtual reality, augmented reality, or other AI models that generate voice or video to give the personas a more realistic look and feel. This could enable personas to be used in the metaverse to, for example, map customer behavior in virtual retail outlets or to gauge public reaction to new traffic rules.

In some embodiments, personas may be able to interact, driven by one LLM or multiple instances of an LLM. This could enable, for example, a digital focus group to be used to gather information without the current need to find and schedule actual people. For example, a persona made to model an interviewer could ask questions about products to multiple personas made to model consumers. The consumer personas could interact when providing their feedback and the interviewer persona could use that feedback to generate follow-up questions.

In one or more embodiments, a computer network provides connectivity among a set of nodes, which may be local to and/or remote from each other and connected by a set of links. A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

In an embodiment, various deployment models may be implemented by a computer network, including but not limited to a private cloud, a public cloud, and a hybrid cloud. In a private cloud, network resources are provisioned for exclusive use by a particular group of one or more entities, such as corporations, organizations, or people. The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

Embodiments are directed to a system with one or more devices that include a hardware processor and that are configured to perform any of the operations described herein and/or recited in any of the claims below. In an embodiment, a non-transitory computer readable storage medium comprises instructions which, when executed by one or more hardware processors, causes performance of any of the operations described herein and/or recited in any of the claims. Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAS, or NPUs with custom programming to accomplish the techniques. In some examples a graphics processing unit (GPU) may be adapted to perform the methods described above. The special-purpose computing devices may be desktop computer systems, portable computer systems, handheld devices, networking devices or any other device that incorporates hard-wired and/or program logic to implement the techniques.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

1. A computer-implemented method comprising:
storing a plurality of personas for use by an artificial intelligence (AI) model in responding to a user prompt, wherein each persona includes one or more of a specified set of demographic information and links to a specified set of data sources;
receiving a selection of one or more personas from the plurality of personas for use in responding to the user prompt, wherein the selected one or more personas are selected based on one or more of the specified set of demographic information and the specified set of data sources;
determining, by the AI model, one or more data source best able to provide an answer to the user prompt based on the selected one or more personas;
searching, by the AI model, the one or more data sources based on the user prompt and the one or more selected personas; and
generating, by the AI model, an answer to the user prompt based on search results obtained from the one or more data sources and based on the demographic information of the one or more selected personas.

2. The computer-implemented method of claim 1, wherein the selected persona is a general persona.

3. The computer-implemented method of claim 2, wherein receiving a selection of one or more personas comprises receiving the one or more selected personas from among a group of pre-established personas, each pre-established persona differing in one or more of demographics, biases, and subject matter knowledge.

4. The computer-implemented method of claim 1, wherein receiving a selection of one or more personas comprises receiving, by the AI model, a selection of a subject matter expert (SME) persona.

5. The computer-implemented method of claim 1, wherein determining one or more data sources comprises receiving, by the AI model, a selection of a desired data source.

6. The computer-implemented method of claim 1, further comprising determining, by the Al model, a search service best able to provide the answer to the user prompt.

7. The computer-implemented method of claim 6, wherein determining a search service comprises receiving, by the AI model, a selection of a desired search service.

8. The computer-implemented method of claim 1, wherein searching comprises:
generating, by the AI model, an Internet query based on the user prompt; and
executing a web search, by the AI model, using the Internet query as input.

9. The computer-implemented method of claim 1, wherein searching comprises:
generating, by the AI model, a database query based on the user prompt; and
executing a database search, by the AI model, using the database query.

10. The computer-implemented method of claim 1, wherein searching comprises:
vectorizing, by the AI model, a predetermined number of document chunks;
generating, by the AI model, one or more vector-based indices of the document chunks; and
executing, by the AI model, a vector search of the one or more vector-based indices to obtain a predetermined number of document chunks reflective of a best answer.

11. The computer-implemented method of claim 1, further comprising saving the user prompt and the answer to a database for additional training of the AI model.

12. A system comprising:
one or more processors; and
memory storing instructions that, when executed by the one or more processors, cause the system to:
receive a user selection of a persona for use in responding to a user prompt;
interface with an artificial intelligence (AI) model to determine a data source best able to provide an answer to the user prompt;
interface with the AI model to perform a search of one or more data sources based on the user prompt and the selected persona; and
interface with the AI model to generate an answer to the user prompt based on search results obtained from the one or more data sources.

13. The system of claim 12, wherein the selected persona is from among a group of pre-established personas, each pre-established persona differing in one or more of demographics, biases, and subject matter knowledge.

14. The system of claim 12, wherein the instructions cause the system to:
interface with the AI model to perform an Internet query based on the user prompt; and
interface with the AI model execute a web search using the Internet query as input.

15. The system of claim 12, wherein the instructions cause the system to:
interface with the AI model to generate a database query based on the user prompt; and
interface with the AI model to execute a database search using the database query.

16. The system of claim 12, wherein the instructions cause the system to:
interface with the AI model to vectorize a predetermined number of document chunks;
interface with the AI model to generate one or more vector-based indices of the document chunks; and
interface with the AI model to execute a vector search of the one or more vector-based indices to obtain a predetermined number of document chunks reflective of a best answer.

17. A non-transitory machine-readable medium storing instructions executable by one or more processors, the instructions causing the one or more processors to:
receive a user selection of a persona for use in responding to a user prompt;
determine, using an artificial intelligence (AI) model, a data source best able to provide an answer to the user prompt;
search, using the AI model, one or more data sources based on the user prompt and the selected persona; and
generate, using the AI model, an answer to the user prompt based on search results obtained from the one or more data sources.

18. The non-transitory machine-readable medium of claim 17, wherein the instructions further cause the one or more processors to:
interface with the AI model to perform an Internet query based on the user prompt; and
interface with the AI model execute a web search using the Internet query as input.

19. The non-transitory machine-readable medium of claim 17, wherein the instructions further cause the one or more processors to:
interface with the AI model to generate a database query based on the user prompt; and
interface with the AI model to execute a database search using the database query.

20. The non-transitory machine-readable medium of claim 17, wherein the instructions further cause the one or more processors to:
interface with the AI model to vectorize a predetermined number of document chunks;
interface with the AI model to generate one or more vector-based indices of the document chunks;
interface with the AI model to execute a vector search of the one or more vector-based indices to obtain a predetermined number of document chunks reflective of a best answer.
